(19) United States
(12) Patent Application Publication
(10) Pub. No.: US 2003/0177069 A1
(43) Pub. Date: Sep. 18, 2003

(54) Real time inventory display and retail sales system

(76) Inventor: Joseph Joseph, Hewlett, NY (US)

Correspondence Address: Stephen E. Feldman, P.C., 12 East 41st Street, Suite 1302, New York, NY, 10017, US

(21) Appl. No.: 10/094,856

(22) Filed: Mar. 12, 2002

(51) Int. Cl. G06G 1/14; G06F 17/60

(52) U.S. Cl. 705/22

(57) ABSTRACT

An inventory display and sales system at the retail level of commerce provides for the display of only merchandise that is listed in the store's inventory and is in-stock at the time inquiry is made for the product. A receiving or incoming product sub-system checks each incoming product with merchandise listed on an in-stock inventory carried by the store. Merchandise not listed on the inventory are identified and defined by the characteristics of the merchandise. An image of the merchandise is taken by a digital camera and stored in a RAM memory, for sales presentation. The merchandise listed on the inventory list is placed in stock and the in-stock count for that product is up-dated. Merchandise requested for display at customer positions are searched for in inventory, making certain the merchandise is in stock before display. Data, including the inventory listing and product quantity in stock, is up dated when merchandise is sold and removed from stock. Special orders for out-of-stock merchandise are minimized. Closing of sales is maximized.

### BACKGROUND OF THE INVENTION

1. Field of the Invention

The present invention relates to a system for the display of on sale merchandise, with a running inventory of the merchandise displayed. In particular the present invention relates to a real time system for the control of the inventory of items or merchandise displayed and offered for sale to customers, at the retail level of commerce.

2. Prior Art

Various systems exist for the display, the selecting and the purchase of merchandise in a commercial establishment both on a real time basis and on a catalog basis. Catalogs are usually used to display or advertise a complete inventory of goods or merchandise whether or not the merchandise shown in the catalog are in stock, so as to execute an immediate, real time sale or at least some of the merchandise shown is out-of-stock, so that if the merchandise selected is out-of-stock, the merchandise selected must be on special order, resulting in a delayed sale. The display of merchandise for purchase over the Internet at a web site corresponds to purchasing merchandise from a catalog where the merchandise is not necessarily in stock. The purchaser can neither handle nor try on the merchandise, if the merchandise should be of such character, nor can the purchaser feel or handle the merchandise displayed. Making purchases over the Internet does have the advantage of shopping at home but immediate possession of the merchandise purchased over the Internet is not a reality.

There are, in the prior art, teachings of systems that aid the shopper in the selection of merchandise and systems that show the shopper, when shopping for apparel, how the selected apparel will look on the shopper. An example of some relevant prior art may be found in the U.S. Pat. Nos.

| | | |
|---|---|---|
| #3,757,037 | issued to Bialek | Sep. 04, 1973 |
| #4,964,043 | issued to Galvin | Oct. 16, 1990 |
| #5,195,030 | issued to White | Mar. 16, 1993 |
| #5,206,804 | issued to Thies | Apr. 27, 1993 |
| #5,216,594 | issued to White et al | Jun. 01, 1993 |
| #5,339,252 | issued to White et al | Aug. 16, 1994 |
| #5,383,111 | issued to Honima et at | Jan. 17, 1995 |
| #5,515,268 | issued to Yoda | May 07, 1996 |
| #5,539,677 | issued to Smith | Jul. 23, 1996 |
| #5,878,401 | issued to Joseph | Mar. 02, 1999 |
| #5.940,808 | issuedto Joseph | Aug. 17, 1999 |
| #5,946,665 | issued to Suzuki et at | Aug. 31, 1999 |
| #6,101,485 | issued to Fortenberry et at | Aug. 08, 2000 |

The patent to Bialek, U.S. Pat. No. 3,757,037 teaches a merchandise image retrieval system using a tape or a cassette to store images of merchandise thereon and to retrieve and display merchandise on sale. Index numbers identify the units of merchandise and retrieval is made according to the index number of the item. Images may be advanced and/or reversed for examination and comparison. The patent to Galvin, U.S. Pat. No. 4,964,043 teaches a network for identifying, selectively viewing and selectively ordering speed reduction gearing equipment using a computer network where remote computers are connected to a master computer by telephone lines. Complete data on the gearing equipment for display and sale is stored in a Read Only memory (ROM) of the master computer of the network. Requests from remote terminals are sent to the master by hard wire lines. Data on the gearing equipment is transmitted from the master unit to the remote unit. Acceptance or rejection of the displayed merchandise is made at the remote unit by the customer. The patents to White, U.S. Pat. No. 5,195,030; to White et al U.S. Pat. No. 5,216,594; and to White U.S. Pat. No. 5,339,252, each patent relates to footwear, the scanning and measuring of the foot, the manufacture of lasts for manufacturing footwear for the scanned and measured foot, and the distribution of footwear according to local preferences of footwear style, the shape of the feet of local people and the size of the feet of local people. A style of footwear is electronically suggested in accordance with the shape and size of a customer's foot. The foot is imaged with the suggested footwear in overlay on the image of the foot and the image is moved to show how the footwear reacts on the foot to such movement. Lasts, for the manufacture of footwear, are made from the shape and size of the foot as scanned by apparatus in the system. Foot shape and size data from a plurality of point of sale locations of a plurality of measured feet provide a database for footwear lasts with automatic up-dating each time a foot is measured in shape and size. Footwear made from such lasts are distributed according to the database information. A foot size sensing device determines a foot size data when the foot is measured for determining the proper fit of a predetermined footwear style. The data is fed to a style selection mechanism for selecting a particular style of footwear to be manufactured from the foot size/shape data. The patent to Thies et al U.S. Pat. No. 5,206,804 teaches a system for electronically measuring a customer's foot and storing the measurement data with a customer identification and customer style preference. A footwear catalog including footwear images and customer style preference data is stored for future reference. A visual display mechanism for displaying images of the size and shape of a measured foot and any data related to the measured foot, with suggested footwear size and style for the measured foot, along with customer footwear style preference is taught. The patent to Homma et al U.S. Pat. No. 5,383,111 teaches a system for controlling the positions of articles displayed to shoppers. A desired position and location of an article displayed for sale and its relationship to other articles also on display is established, from a sales presentation point of view. During the sales day, merchandise on display is removed from the point of display by sale, by handling and return and by replacement of stock sold. The patent teaches the reestablishing of a desired display position for all merchandise on display in an establishment. The patent to Yoda U.S. Pat. No. 5,515,268 teaches an electronic system for sales presentation of apparel, selected by a customer from a list or catalog of products stored in a computer system. The physical characteristics of the customer are determined by scanning the person. The size of the product selected is determined from the physical characteristics. A real time image of the customer attired in the selected product is displayed showing the customer how the customer will look in the selected attire. Color and/or pattern change as well as size change may be made in real time image. Different attire may be tried on, all without the customer moving from the monitor displaying the images. The patents to Joseph U.S. Pat. No. 5,878,401 and U.S. Pat. No. 5,940,808 teach apparatus for displaying alternate or substitute items for out of stock items selected by a customer, although the selected item is in a general inventory. In the teaching of the '401 patent, when a customer requests a specific item from an inventory of items, if the requested item is in stock, the item requested is displayed. If the item requested is not in stock, a substitute or alternative item is displayed. A complete database of items in inventory include all styles, a full range of sizes for each style, all colors and/or patterns of each style and size, of each item, that is, dress, coat, skirt, pants, slacks, belt, blouse, shirt, etc. The database includes suggested alternatives for each item in inventory. A bar code on each item and a bar code reader are used to identify items on display. The patent to Suzuld et al U.S. Pat. No. 5,946,665 and to Fortenberry et al U.S. Pat. No. 6,101,485 relate to Internet shopping and while each teaching relates to the retail sale of merchandise, the teachings in these patents are not applicable to the present invention. It should be noticed that when practicing any of the teachings discussed above, that the seller is displaying and offering for selling, and the purchaser shopping for and/or purchasing merchandise that is in the inventory of the seller but not necessarily in-stock in the seller's inventory, that is, the merchandise is not in the hands of the seller, when the seller is offering the merchandise for sale and/or actually selling the merchandise. The merchandise is purchased by the customer and later, as much as a week later, delivered to the customer. This is essentially a ‘futures sale’ in that the price of the merchandise purchased could change between the time the purchase is made and the time the merchandise is delivered.

### OBJECTS OF THE INVENTION

It is an object of the present invention to provide an active display of current in-stock items in a retail establishment in order to enhance immediate sales as opposed to catalog or sale-order sales.

Another object of the invention is to actively display a current inventory of in-stock items, available for immediate sale.

A further object is to provide a system for up-dating an inventory listing in stock items, on a check-in check-out basis and present for sale, only items that are in stock at the time a customer makes a request for an item.

A still further object of the invention is to provide a system which, when a particular item requested by a retail customer is out-of-stock, to limit suggested alternative items to such customer, to those items that are in stock, at the time of the potential purchase by the customer.

### SUMMARY OF THE INVENTION

The present invention has broad application with respect to merchandise marketed and sold at the retail level of commerce. Although a great variety of merchandise marketing and sale may be the subject of the present invention, one of the largest retail merchandise fields in which the invention may be practiced is the field of apparel retail sales. In the apparel field there is a very wide variety of merchandise. There is separate apparel marketed for each season of the year and, within the year, different holiday apparel. For each seasonal and holiday market there are men's cloths, women's cloths and children's cloths, for all ages, for both male and female persons. Cloths for day and cloths for night, cloths for awake and cloths for sleeping; there is headgear and footwear, cloths for indoors and cloths for outdoors, for people of all shape and size. There is off the rack clothing and custom made clothing, fitted clothing and one-size-fits-all clothing. It is not unusual to see clothing for animals. This makes a tremendous volume of apparel.

The tremendous volume of apparel lead to separating the apparel retail market into many classes. Many individual outlets or stores market and sell a limited number of classes of apparel. In addition there are some speciality retail clothing stores that are highly specialized. This separation of the apparel marketing brought about the advent of department stores that market and sell many different classes of apparel. Under separation marketing of apparel, a purchaser would go to different establishments or stores, normally under separate and/or different roofs, to purchase different classes of apparel. Under department store marketing of apparel, a purchaser may go to one store to purchase a large variety or a large number of different classes of apparel. Even department establishments which retail apparel, limit themselves as far as some classes of apparel are concerned. One reason is because of the large area or floor space needed to display such volume of goods for sale. The electronic marketing and sale of merchandise has again changed the approach to marketing and selling apparel, at retail. As seen in the prior art, the promotion of merchandise for sale is done by visual display of images of the product or goods, rather than by physical display of the product. In electronic marketing and sale of apparel a large space is no longer needed for displaying goods. A much smaller space is needed, only sufficient space to secure several monitors and interfaced key boards or terminals. The larger space is needed for storage of in-stock inventory. Here the inventory is again a problem because with so many different products how many of each item does the retailer keep in stock. It is very difficult to predict when a specific item will become a hot-sale-item. Electronic shopping, in its attempt to, ‘not lose a sale’, has moved to take from the purchaser the power of selection, especially when the item selected by the purchaser is not an in-stock item. This is electronic hard-selling and is often considered by the purchaser to be an insult to the purchaser.

The apparel field has many different classes of merchandise, the hardware field has may different items of merchandise, and the furniture field has many different classes as does the field of household merchandise, for example. The present invention is described in a retail marketing and sales environment of footwear, in particular shoes. A preferred aspect of practice of the invention is described with respect to the marketing and sale of shoes. An alternate aspect of the invention is described using the same environment.

In keeping with the objects of the invention, there is provided a system for the display of shoes in a retail shoe store. Shoes for sale are displayed in such a manner that the displayed shoes are representative of the shoes actually in inventory, that is, in-stock at the time a request for the display of a shoe is made by a customer. The inventory of current, in-stock shoes is maintained by immediately deleting, from inventory, any product passing out of the store, through a point of sale terminal. Incoming shoes, received in inventory are immediately added to the inventory. If the shoe received is a new product, such as a new style of shoe, for example, the new stock item is added to the inventory. If an incoming shoe is a product already listed in the inventory, the quantity of the particular shoe held in-stock will be incremented or up-dated. For each item in inventory there is a corresponding image stored in the memory of the network that may be displayed over a monitor. If a shoe is not in inventory, honesty prevails and the customer is informed that the particular shoe is out-of-stock.

In the preferred aspect of the invention, the inventory of merchandise, shoes, for example, is a listing, by type, style, size, color and/or pattern, all shoes, or pairs of shoes, in stock and available for immediate, real time sale. All marketing is done by display of images of shoes in inventory. Thus all marketing is limited to shoes actually carried in stock and available for immediate sale. This is real time marketing and selling where marketing is limited to in-stock shoes and sales are made on an immediate basis.

In another aspect of the invention the inventory of merchandise, shoes, for example, is a listing of the shoes that may be purchased at or through the store. A separate, in-stock listing of shoes is maintained, listing only shoes currently in-stock, in the store and available for immediate sale. Marketing, by image display, is limited to those shoes on the list of in-stock shoes so that real time marketing and real time selling is maintained.

### BRIEF DESCRIPTION OF THE DRAWINGS

FIG. 1 is a representation, in perspective view, of a wall display space in a shoe store practicing the present invention;

FIG. 2 is a representation, in block diagram, of a computer system which may be used for practicing the invention;

FIG. 3 is a flow diagram of customer interaction using the computer system represented in FIG. 2;

FIG. 3a is a flow diagram of another aspect of the invention, representing customer interaction using the computer represented in FIG. 2; and;

FIG. 4 is a flow diagram for handling in-coming stock using the computer system represented in FIG. 2.

### DETAILED DESCRIPTION OF THE INVENTION

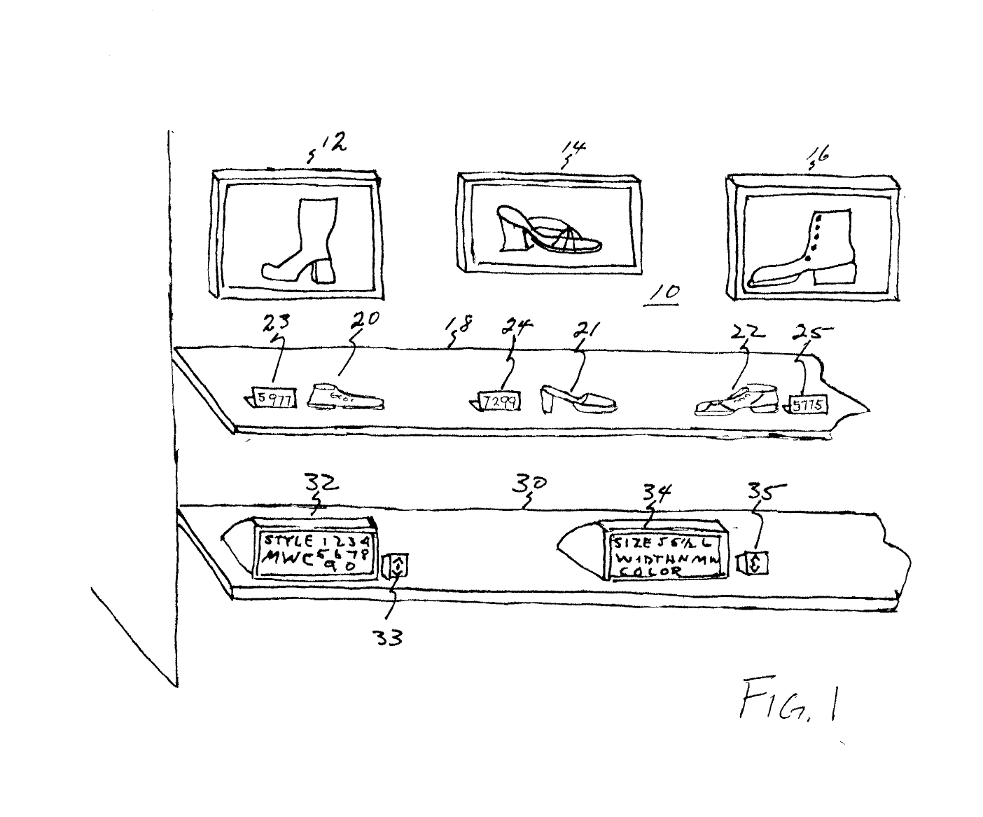

For illustration purposes, one mode for practicing the invention is described herein. The embodiment described is an inventory control and merchandise display system for a commercial retail shoe store or outlet. FIG. 1 represents a portion of a wall in the customer section of a retail shoe store. On the wall 10 are displays 12, 14 and 16, each of which show a shoe, with three different shoes represented. The displays 12, 14 and 16 may display static images on a video screen, for example. The images may be changed periodically, as controlled by a computer, to which each display screen is interfaced. Technology for displays of both motion and stable images is readily available. Although three display screens are represented, more than three display screens may be used, if desired. A combination of stable and static images may be used, if desired.

Below the display screens 12, 14 and 16 is a shelf 18 on which a display of a plurality of physical shoes are represented. Shoes 20, 21 and 22 are represented, each shoe being different from each other shoe in style and/or color of shoe. Next to each shoe is a card holder 23, 24 and 25 into which may be inserted a card which may identify the shoe and/or indicate the price of the shoe. Although three shoes are represented on the shelf, more than three shoes may be placed on the shelf, if desired. The shelf supporting the shoes may be a plurality of shelves, each shelf designed to support one or two shoes, rather than a full shelf, supporting a plurality of shoes.

A second shelf 30 is represented which supports a plurality of customer positions or customer operated computer terminals, represented at 32 and 34. Customer positions may be separated from each other by dividers, not shown, providing privacy for the customer. There may be more than two positions, as represented. Each customer terminal 32 and 34, is represented as a touch screen/display device, although a computer key board and a computer mouse may be used, along with a monitor, if desired. The touch screen technology is preferred because the touch screen is simpler to use than separate key board, computer mouse and screen. Also, a touch screen/display device is less prone to theft. Scroll controls 33 and 35 are represented with each touch screen/display although a scroll control may be integrated into the touch screen. At the customer position or terminal, a customer may selectively request to view the image of a shoe in the inventory of the store. The inventory of shoes is listed on the screen and from the listed inventory, the customer may select a shoe to be imaged on the screen at the customer position. Each shoe on the inventory is identified by a code number. Assume the customer selects a shoe from inventory listing. The code number of the shoe selected by the customer is used to retrieve the image of the selected shoe, from storage in the computer memory. The customer may also select a shoe by defining the shoe. The shoe may be defined by the type, (men's, women's or children's, with age range for a child's shoe) the style, the color and/or pattern and the size of the shoe. The computer searches the inventory to determine whether or not a shoe, defined by the specific characteristics, is in stock. If the shoe defined by the customer is in inventory, that is, in stock, an image of a shoe, having the defined characteristics is displayed on the screen. The customer is assured that the image displayed at the customer position, corresponds to the shoe defined by the customer in his or her request, and further assured that the shoe displayed is in inventory, that is, in stock, in the store. If the customer wishes to purchase the shoe, the shoe is drawn from stock and the purchase is made. The sale is completed at a sales counter or check out counter. The inventory is then up-dated by removing data of the shoe sold from the inventory. If the shoe sold is the last shoe in inventory, data identifying the shoe and the image of the shoe is removed from inventory and from storage. If the shoe sold was one of several of the same shoe in inventory, the quantity of the particular shoes in inventory is reduced, by one. Shoes are normally sold in pairs and it is assumed here that the term ‘shoe’ could relate to one shoe or a pair of shoes, as determined by the context of the sentence.

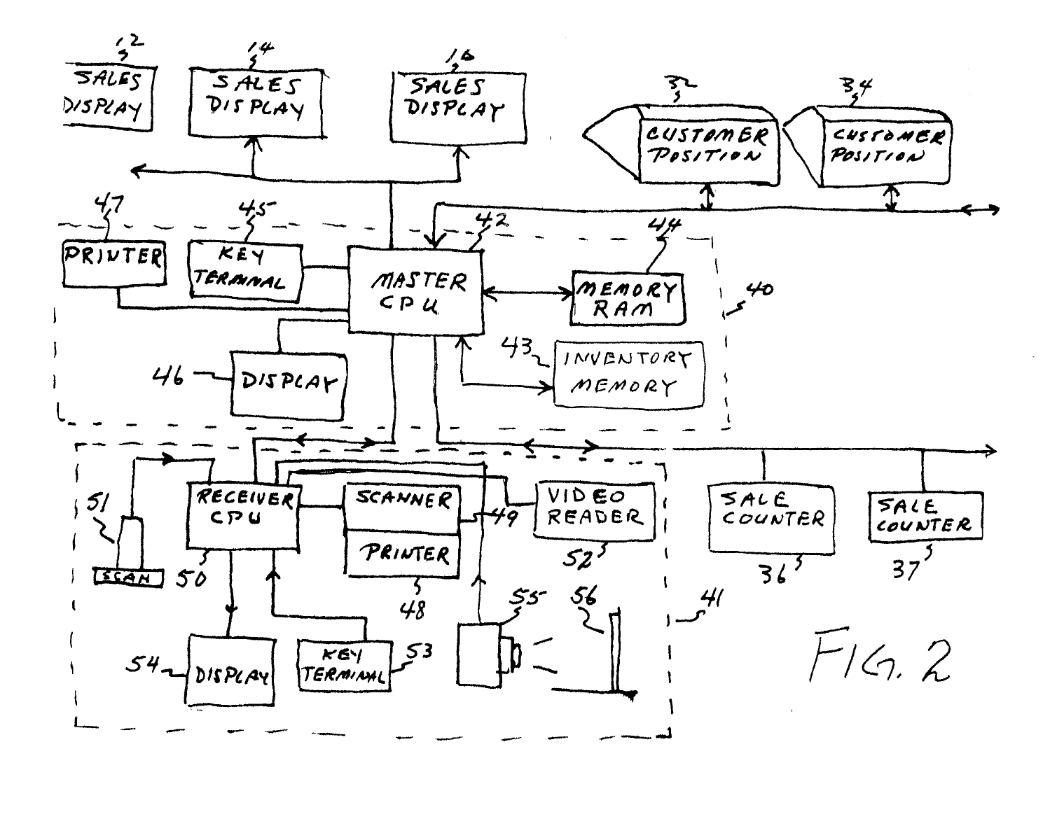

FIG. 2 is a block diagram representing a computer system that may be used for practicing the invention. The computer system is preferably a network of master computer 40 and at least one secondary computer 41. The secondary computer may be identified as a receiver computer or incoming computer because the secondary computer may be primarily handling the incoming merchandise, received into the store. The SALES DISPLAY, blocks 12, 14 and 16, CUSTOMER POSITION, blocks 32 and 34 and SALES COUNTER or check-out positions, blocks 36 and 37 interface with the MASTER CPU, block 42 but are located in the customer or sales section of the establishment. The master computer 40 is preferably located in the business office while the secondary computer 41 may be located in the stock receiving or storage area of the establishment.

The master or primary computer 40 includes the central processing unit MASTER CPU, block 42, a means for storing a running inventory, INVENTORY MEMORY, 43, a means for storing and retrieving image data, MEMORY RAM, block 44, a key board, KEY TERMINAL, block 45, a visual read out, DISPLAY, block 46 and a hard copy read out, PRINTER, block 47. The SALES DISPLAY, blocks 12, 14 and 16, providing a means for general display of images of shoes for sale, the customer terminal and display means, CUSTOMER POSITION, blocks 32 and 34 and the point of sale means, SALE COUNTER, blocks 36 and 37 are located in the customer sales area and interface with the master computer 40. A list of shoes, in stock, is kept in INVENTORY MEMORY 43. Each shoe (pair of shoes) listed in inventory is defined by type, style, size and color/pattern. Preferably, the definition of the shoe is reduced to a code, a digital code, for example. Included in the listing is the quantity of identical shoes in stock. This is a running inventory of the shoes in stock and the quantity of each defined shoe.

When a shoe (pair of shoes) is received at the receiving or incoming shoe area, the shoe is defined by type (man, woman, child), style (dress, casual, work, etc.), size and color/pattern. The definition of the shoe, that is, the type, style, size and color/pattern is usually printed on the box containing the shoe and on the shoe, in a bar code, by the manufacturer of the shoe. The bar code is translated into digital data which may be stored in or removed from a computer memory. If the incoming shoe is new, the shoe definition is added to the inventory memory 43 along with the quantity of shoe (in this case one pair), having that definition. If the shoe is already listed in inventory, the quantity is incremented. When a shoe is sold and passes out of the store at the point of sale, the shoe is identified and data on the identified shoe is changed or deleted in the inventory memory 43. If the shoe sold is one of a plurality in stock, the quantity of in-stock shoes is reduced by one. If the shoe sold is the last of its definition in stock, data on the shoe is deleted from inventory.

The secondary or receiving computer 41 includes the central processing unit, RECEIVING CPU, block 50 interfaced with the MASTER CPU 42. The secondary computer 41 includes a flat bed SCANNER, block 49, a PRINTER, block 48, a key board, KEY TERMINAL, block 53, a bar code SCANNER, block 51, a monitor or DISPLAY, block 54, a VIDEO READER, block 52 and a digital camera 55. A changeable back ground 56 is provided for enhancing images of shoes taken by the digital camera 55. The bar code scanner 51 provides a means for reading the bar code printed on boxes for identifying the shoes contained in the box, without opening the box. The identifying bar code is translated into digital data that may be stored in the memory of a computer. The flat bed scanner 49 provides a means for scanning printed data provided by the manufacturer and inputting the printed data into the RAM storage of the computer network, for display to customers. The video reader 52 provides a means for reading video data, on a video cassette, for example, provided by the manufacturer on a specific shoe, for example, and inputting the video data into the RAM storage of the network for display to customers. The digital camera 55 is provided for taking images of a shoe, and inputting the image data into the RAM storage of the network, for displaying the image to a customer. A “stage” is provided on which to place a shoe, when taking an image of the shoe, by the digital camera. The changeable back ground 56 is provided for enhancing the image of the subject of the image. The key terminal 53 is used to input instructions to the CPU 50 and/or to modify and/or amend data inputted into the network and/or commands written into the computer. Data on a particular shoe in inventory, including an image of the shoe, printed data on the particular shoe, scanned and stored in the RAM memory and/or video data on the particular shoe read and stored in the RAM memory is retrieved from the memory and displayed to a customer, at the customer position, in response to a request by the customer from the customer position. Only data on shoes currently listed in inventory and held in stock for immediate sale is displayed to customers. This is a real time display of sales data, made in response to a request for such information on a particular shoe.

The sales counters, or check out positions, or point of sale positions represented at 36 and 37 interface with the MASTER CPU 42 and input sales data, including instructions to remove from storage, data relating to a shoe sold and removed from the premises. Removal of data may include reducing a number representing a quantity of an identified shoe listed in inventory, by one or removing data on the identified shoe from inventory and from the RAM memory, if the identified shoe is the last shoe of that definition in inventory.

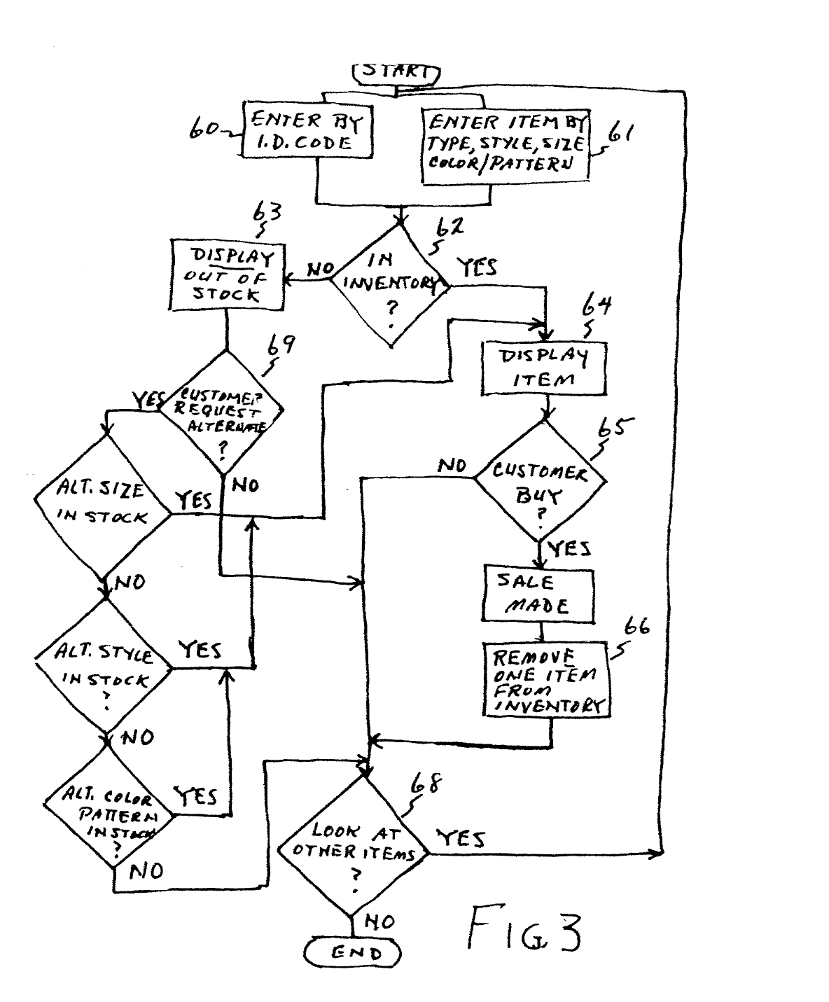

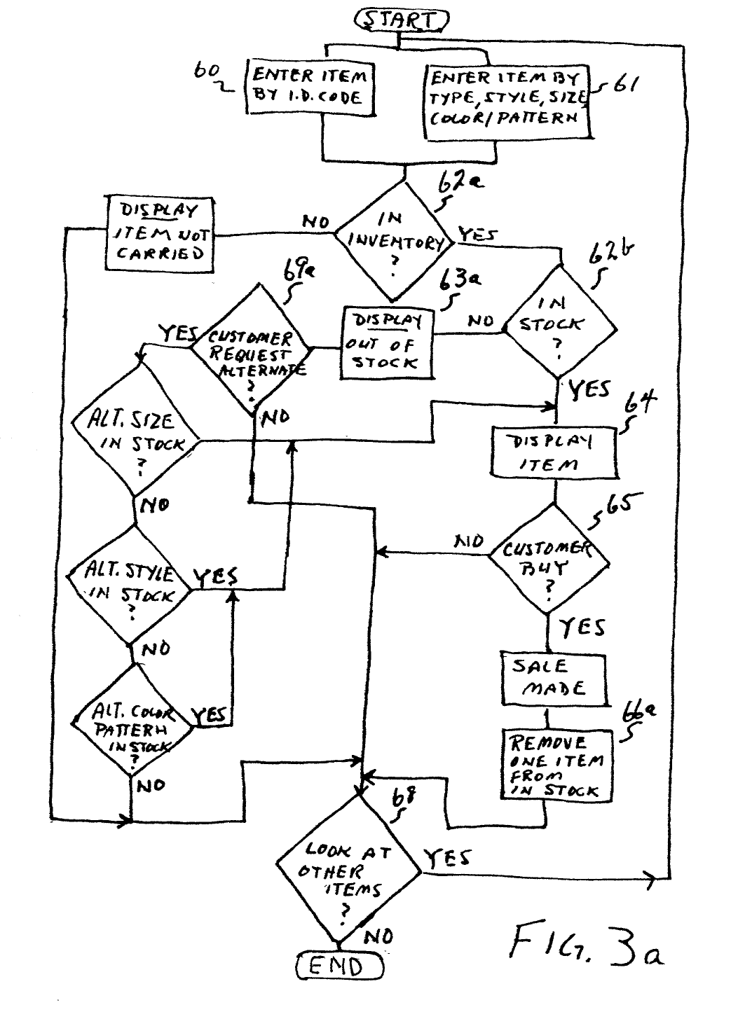

FIG. 3 is a flow diagram of customer interaction from the customer position of the computer network. For the most part the flow diagram is self explanatory. The customer expresses a desire to enter into interaction, represented by START. The customer enters the identity of the shoe he or she wishes to see by either entering an identifying code 60, or by listing the type, style, size, color and/or pattern 61. The computer searches the inventory 62, listing the shoes in stock, in the store. If the defined shoe is in inventory, YES, the identified shoe is displayed 64 on the screen before the customer. If the customer wishes to purchase the shoe, YES at 65, the sale is made and data on the shoe so sold, is removed from inventory, 66. If the shoe is one of two or more of the exact same type, style, size and color/pattern, data, representing the quantity of shoes in stock, is reduced by one. If the shoe is the last of its type, style, size and color/pattern, data on the shoe is removed from the inventory and from memory/storage RAM. If at 65 the answer is NO, the customer is asked if he or she would like to see or look at other items, 68. If YES at 68, the customer enters a new request at 60 or 61. If there is NO at 68, the interaction terminates.

If the shoe identified by the customer is not in inventory, NO at 62, an OUT OF STOCK is displayed, 63 on the screen at the customer position. The customer is asked, by display on the screen at the customer position, if the customer will accept a substitute or alternate 69. If NO, at 69, the interaction continues to 68. If the customer will consider an alternate or substitute, YES at 69, the computer searches the inventory for an alternate style, size or color/pattern and/or of shoe. If YES, in any of the cases of a suggested alternate, the alternate shoe will be displayed, in image, 64, at the customer position.

FIG. 3a is a flow diagram of customer interaction of another aspect of the invention, from the customer position of the computer network. Some steps of the flow diagram of FIG. 3a correspond to steps in the flow diagram of FIG. 3, and identical call out numbers are used to identify the step. The major difference between the flow diagram in FIG. 3 and the flow diagram in FIG. 3a is, in FIG. 3, there is only one listing of merchandise, the in-stock inventory 62. In FIG. 3a there are two listings of merchandise, a general inventory, 62a listing merchandise sold by the establishment, whether or not in stock at the time, and a second list 62b, which lists in-stock merchandise, or on hand merchandise, ready for immediate sale. The general inventory is not amended when a sale is made. The in-stock inventory or listing is amended when a sale is made, along with a possible amendment to the memory RAM, that is, if the shoe sold is the last on the in-stock listing or in-stock inventory, the memory RAM is amended to delete data on the shoe sold.

The FIG. 3a flow diagram begins the same way the FIG. 3 flow diagram begins. The item or shoe may be identified by code, 60 or by definition 61. The definition of the shoe is searched in the general inventory, 62a. If YES, at 62a a search is made in the in-stock inventory to determine if the defined shoe is in stock, 62b. If YES at 62b, an image of the shoe defined is displayed, 64 at the customer position. If the customer wishes to purchase the shoe, YES at 65, the sale is made and the shoe so sold is removed from the in-stock listing 66a. If the shoe is the last of its definition listed in-stock, data on the shoe is removed from the in-stock inventory list and from the RAM memory. If there are additional shoes of the same definition listed in-stock, the quantity of the shoes in-stock is reduced by one. The general inventory is not amended or up-dated. If NO at 62b, OUT OF STOCK 63a is displayed at the customer position. The customer is also asked, by display, if an alternate shoe is requested, 69a. If NO at 69a, the customer is asked, by display, if he or she wishes to request other items, 68. If the general inventory listing 62a is NO, ITEM NOT CARRIED is displayed at the customer position and the flow diagram continues to 68. If the customer requests an alternate, YES at 69a, a search in the in-stock inventory is made for alternate size, style and color/pattern.

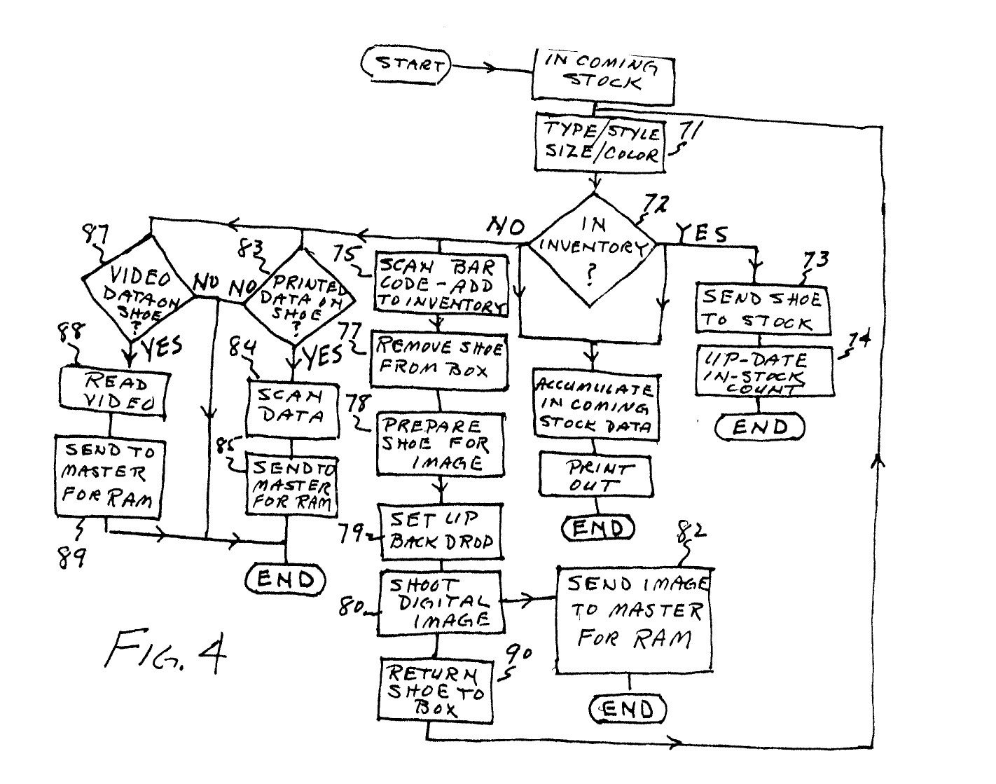

FIG. 4 is a flow diagram of the interaction in the stock receiving area in support of the invention where incoming stock is defined by type, style, size and color/pattern 71. If the defined shoe is listed in inventory 72, YES, the shoe is sent to stock, 73 and the in-stock count of that specific shoe type, style, size and color/pattern is incremented by one, 74.

If the defined shoe is not listed in the inventory of products in stock in the store, NO at 72, which would make this particular type, style, color/pattern or size a new product, the bar code on the box, which identifies and defines the shoe inside the box, is scanned 75, by the scanner 51. The scanner 51 may be a hand held unit for reading bar codes, as represented at 51 or may be a stationary unit, built into a counter or other facing. The shoe, identified by the bar code, is added to the inventory of the store. The new product is removed from the box 77 and the shoe is prepared for imaging 78, by cleaning and/or polishing and “staging” the shoe. The shoe may be fitted with a manikin, if desired, to show how the shoe looks on a foot. The digital image of the shoe is shot 80 and the image sent to the master computer 43 for storage in the memory RAM 82.

If there is printed data on the new product, YES at 83, the printed data is scanned 84 by the flat bed scanner 49 and the data is sent to the master computer for storage in the RAM 85. If the manufacturer has provided video data on the new product 87 YES, the video is read, 88 by use of the video reader 52. The video data so read is sent to the master computer for storage in the RAM 89. It will be apparent, to those skilled in the art, that a program is written in the master CPU that provides for selective retrieval of the data stored in the RAM upon proper request by a customer operating the customer position 32, for example.

After the digital image of the new shoe or product is made 80, the shoe is returned to the box 90 and the interaction continues via return to the step 71. This time through the incoming or receiving goods processing, the inventory contains data on the shoe and there is a YES at 72. The shoe is then sent to stock 73 and the count of in-stock shoes, for the particular shoe is incremented by one.

Since sales displays at 12, 14 and 16, for example, are all of in-stock data, the customer is shown only merchandise available for immediate sale. Al sales information displayed through a customer position, is retrieved from the RAM and is data on in-stock merchandise. Alternatives or substitute merchandise, provided at the request of the customer, are only in-stock merchandise. This minimizes special orders for out-of-stock items and maximizes the closing of sales.

In the foregoing description of the invention, referenced to the drawings, certain terms have been used for conciseness, clarity and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented or described.

Having now described a preferred embodiment of the invention, in terms of features, discoveries and principles, along with certain alternative aspects, other changes that may become apparent to those skilled in the art may be made, without departing from the scope of the invention defined in the appended claims.

What is claimed is:

1. A real time inventory display and selection system for displaying items for sale at a retail level of commerce whereby images of items displayed are representative of items listed in an in-stock inventory at the time a request for the display of an image of an item of said items is made for minimizing the quantity of special orders for out-of-stock items and for maximizing the closing of sales, said system comprising:
a) a first computer means including a first storage means for storing a first data relating to items in stock and a second storage means for storing a second data relating to items listed in said first data, and a data retrieval means and a display means interfaced with said first computer means, for retrieving at least a part of said second data for displaying said at least a part of said second data at said display means;
b) a second computer means interfaced with said first computer means for keeping said first data and said second data current, said second computer means including an item detector means for detecting and identifying an item received for stock for adding data related to said item received for stock to said first data; and
c) a point of sale means interfaced with said first computer means for detecting and identifying an item from stock, sold and passed through said point of sale means for changing said first data where said first data relates to said item sold.

2. A real time inventory display and selection system as in claim 1 where in said first data is an inventory listing of items received and stored in stock.

3. A real time inventory display and selection system as in claim 2 wherein said listing of items is a list of coded data.

4. A real time inventory display and selection system as in claim 2 wherein said first data is a coded data representative of a definition of each respective item stored in stock.

5. A real time inventory display and selection system as in claim 4 where in said each item stored in stock is a pair of shoes.

6. A real time inventory display and selection system as in claim 5 wherein said coded data defines each said pair of shoes by type, style, size and color/pattern.

7. A real time inventory display and selection system as in claim 1 wherein said second data relates to an image repreenting an item in stock.

8. A real time inventory display and selection system as in claim 7 wherein said second data is an image that relates to a first part of said first data and said first part of said first data represents a specific item in stock.

9. A real time inventory display and selection system as in claim 7 wherein said second data is an image data that relates to a first part of said first data and said first part of said first data represents a specific item in stock and said image data represents said specific item in stock.

10. A real time inventory display and selection system as in claim 1 wherein said item detector means is a bar code reader means for reading bar code indicia printed on a box supporting said item, for identifying said item without opening said box.

11. A real time inventory display and selection system as in claim 10 wherein said bar cod e is translated in a definition of said item.

12. A real time inventory display and selection system as in claim 11 wherein said item is a pair of shoes.

13. A real time inventory display and selection system as in claim 12 wherein said pair of shoes are defined by type, style, size and color/pattern.

14. A real time inventory and display system as in claim 1 and in which said second computer means includes a video read means for reading a video data provided on said item received for stock and inputting said video data into said first computer means for storing said video data in said second storage means.

15. A real time inventory display and selection system as in claim 1 and in which said second computer means includes a flat bed scanner means for scanning and reading a printed data provided on said item received for stock and for inputting said printed data into said first computer means for storing said printed data in said second storage means.

16. A real time inventory display and selection system as in claim 1 and in which said second computer means includes a digital camera means for taking an image of said item received for stock for storing said image in said second storage means.

17. A real time inventory display and selection system for promoting the sale of items at a retail level of commerce whereby images of items displayed are representative of items listed in an in-stock inventory at the time a request for the display of an image of an item of said items is made, for minimizing the quantity of special orders for out-of-stock items and for maximizing the closing of sales, said system comprising:
a) first computer means including
i) a first storage means for storing a first data relating to items in stock,
ii) a second storage means for storing a second data relating to items listed in said first data;
b) a second computer means interfaced with said first computer means, said second computer means including
i) a bar code scanner means for reading a bar code for identifying items received for in-stock items, for up dating said first data for storage in said first storage,
ii) a digital camera means for taking an image of an item of said items received for in-stock items, for providing image data relating to said item received for said in-stock items for said second data for storage in said second storage means,
iii) a flat bed scanner means for reading a printed data relating to said item received for in-stock items, for providing a data corresponding to said printed data for said second data for storage in said second storage means;
c) an item selection and image display means for selecting an item from a listing defined by said first data and for retrieving an image from said second data related to said item selected from said listing and for displaying said image; and
d) a point of sale means for receiving and identifying an item taken from said in-stock items and sold, for deleting data from said first dat relating to said item from said in-stock items and sold, for further up dating said first data.
